(19) United States
(12) Patent Application Publication
(10) Pub. No.: US 2012/0296605 A1
(43) Pub. Date: Nov. 22, 2012

(54) METHOD, COMPUTER PROGRAM, AND SYSTEM FOR PERFORMING INTERPOLATION ON SENSOR DATA FOR HIGH SYSTEM AVAILABILITY

(75) Inventors: Karim Hamzaoui, Kanagawa (JP); Shohei Hido, Kanagawa (JP); Shoko Suzuki, Kanagawa (JP)

(73) Assignee: International Business Machines Corporation, Armonk, NY (US)

(21) Appl. No.: 13/473,845

(22) Filed: May 17, 2012

(30) Foreign Application Priority Data
May 17, 2011 (JP) JP 2011-110340

(51) Int. Cl. G06F 11/30

(52) U.S. Cl. 702/184; 702/185

(57) ABSTRACT

Provided is a method applied to a system including a plurality of sensors, a proxy, and a server. The method includes: measuring objects by the plurality of sensors to obtain first measurement values; computing a correlation among the first measurement values by the server based on the first measurement values; computing an actual measurement value of a second measurement value by the proxy based on the first measurement values and a given function; verifying the plurality of sensors by setting one or more sensors as verification target sensors in turn by the server at predetermined timing; computing a predicted value of the second measurement value by the server based on the correlation and the first measurement values obtained from the other sensors; and outputting the predicted value of the second measurement value instead of the actual measurement value thereof at least during the verification of the verification target sensors.

### CROSS-REFERENCE TO RELATED APPLICATIONS

This application claims priority under 35 U.S.C. §119 to Japanese Patent Application No. JP 2011-110340 filed May 17, 2011, the entire text of which is specifically incorporated by reference herein.

### TECHNICAL FIELD

The present invention relates to a technique of achieving high system availability, and particularly relates to a technique of interpolating missing pieces of sensor data by using the known pieces of sensor data.

### BACKGROUND

Generally, system availability is important for control systems, and is particularly important for industrial control systems (ICSs) such as building management systems, power generation control systems, and manufacturing plant systems. Accordingly, even if a certain sensor detects anomalous data indicating a failure, it is desired that the system operate as continuously as possible without stopping any part of the system or the entire system.

Techniques of anomaly detection for ICSs of plants have been disclosed Japanese Patent Application Publication No. 2006-135412 (Patent Literature 1), Japanese Patent Application Publication No. 2010-218301 (Patent Literature 2), and Japanese Patent No. 3449560 (Patent Literature 3). Patent Literature 1 aims to provide a remote supervisory system with such high detection sensitivity that a failure of a monitor target facility can be detected early and accurately, and discloses a technique for “a remote supervisory system including: a sensor information acquisition section for acquiring sensor values of a monitoring target; a prediction model buildup section that obtains the first correlation between sensor values in a normally operating state, builds up a basic prediction model for detecting a failure by using the first correlation, obtains the second correlation among the sensor values of some of the sensors, and builds up a specific failure prediction model providing higher sensitivity to a particular failure of a facility than the basic prediction model by using the second correlation; and a failure detection section for detecting the presence/absence of a failure of the facility on the basis of the difference between the sensor values acquired in a monitoring period and the predicted sensor values, wherein when a failure in the facility is detected on the basis of the basic prediction model, the prediction model buildup section determines a combination of sensors for maximizing the detection sensitivity to the failure and builds up the specific failure prediction model for the detected failure.”

Patent Literature 2 aims to provide an anomaly diagnosis apparatus that estimates the state of a chemical plant through a regression analysis, and automatically identifies the cause of failure when an anomalous state occurs. Patent Literature 2 discloses a technique for an anomaly diagnosis apparatus that performs anomaly diagnosis of a plant by calculating the estimated values of an anomaly detection target in the plant through regression analysis on the measurement values of measurement targets, and by predicting the occurrence of an anomaly through comparison of the estimated value with a predetermined threshold. The anomaly diagnosis apparatus includes an identification method that identifies a measurement value greatly contributing to the estimated value of the anomaly detection target.

Further, Patent Literature 3 aims to provide an improved method and system for monitoring industrial processes and apparatuses, and discloses a method for monitoring at least one of industrial processes and industrial sensors, comprising the following steps: a step of obtaining time varying data from a plurality of industrial sensors; a step of processing the time varying data, comparing sensor signals of the respective sensors, and calculating a time correlation and determining a lag between the sensor signals to get optimum time correlation of the data accumulated from the plurality of industrial sensors; a step of searching the maximum and minimum values of the modified data using the time correlation, thereby determining the full range of values for the data from the industrial sensors; a step of determining learned states of a normal operational condition of the industrial process(es) and the industrial sensors and using the learned states to combine at least one new current actual value of the industrial process(es) and the industrial sensors and to generate expected values of the operating industrial process(es) and the industrial sensors; a step of comparing the expected values to the current actual value of the industrial process to identify a current state of each of the industrial process(es) and the industrial sensors which are the closest to one of the learned states and generating a set of modeled data; and a step of processing the modeled data to identify a pattern for the data and generating an alarm upon detecting a deviation from patterns showing the characteristics of the normal operation.

### BRIEF SUMMARY

However, these conventional techniques all aim for accurate failure detection. The techniques lack a viewpoint of the availability of the system and thus do not provide means for enhancing the system availability.

The present invention has been made in view of the problem. One of the objectives of the invention is to provide a method, a computer program, and a system by which the target system operates as continuously as possible without stopping part of the system or the entire system even if anomalous data indicating a failure is detected from a certain sensor.

When being taken as a method, the present invention is summarized as follows, for example. Specifically, the present invention provides a method applied to a control system including correlated sensors, a proxy, and a server. The method includes the steps of: measuring objects by the multiple sensors to obtain first measurement values of the time-series data of each sensors; computing a correlation among the first measurement values by the server; computing an actual measurement value of a second measurement value by the proxy based on the first measurement values and a given function; verifying the multiple sensors by setting one or more sensors as verification target sensors in turn by the server at predetermined timing; computing a predicted value of the second measurement value by the server based on the correlation and the first measurement values obtained from the other sensors except the verification target sensors among the multiple sensors; and outputting the predicted value of the second measurement value instead of the actual measurement value at least during the verification of the verification target sensors.

Moreover, in the verification step, the method may be configured to verify the multiple sensors by setting one or more sensors as verification target sensors in turn until an anomalous sensor is identified or until all of the sensors are verified. The method may also be configured such that the verification step where one or more verification target sensors among the multiple sensors are verified in turn until an anomalous sensor is identified can be accompanied by further steps; a step of computing the predicted value of the second measurement value by the server based on the correlation and the first measurement values obtained from the other sensors except the verification target sensors among the multiple sensors; and a step of outputting the predicted value of an anomalous sensor by the server at least during a repair of the sensor. Further, the method may also be configured such that with the verification step where one or more verification target sensors among the multiple sensors are verified in turn until all of the sensors are verified, the actual value of the second measurement value is output instead of the predicted value in the output step.

Still further, the other sensors do not include the sensor that is being verified, but include the sensors yet to be verified, the sensors already verified, or the sensors yet to be verified and already verified.

The method can be configured such that in the verification step, the sensors are verified in descending order of contribution to the actual measurement value of the second measurement value. Note that a sensor having a correlation with more sensors can be determined as a sensor with higher contribution. Alternatively, the determination can be made based on a structural dependency among the sensors or using least-angle regression (LARS). Moreover, the method may be configured such that in the verification step, the verification target sensors among the multiple sensors are verified in turn in response to identification of the actual measurement value taking on a predetermined anomalous value.

Additionally, the method may be configured such that the system includes multiple subsystems, each subsystem includes a proxy, and multiple sensors, and the server outputs the predicted value to the subsystems in the output step. Further, the method may be configured such that the system includes a single higher-level subsystem and multiple lower-level subsystems, each of the lower-level subsystems includes a proxy and multiple sensors, and the server outputs the predicted value to the higher-level subsystem in the output step.

As a computer program product, the present invention can provide a computer program for causing a computer to function as the server, for example. As a system, the present invention can provide a system including multiple sensors, a proxy, and a server, for example. In the system, the multiple sensors measure objects to obtain first measurement values, respectively; the server computes a correlation among the first measurement values based on the first measurement values; the server verifies the multiple sensors by setting one or more sensors as verification target sensors in turn at predetermined timing; the server computes a predicted value of the second measurement value based on the correlation and the first measurement values obtained from the other sensors except the verification target sensors among the multiple sensors; and the server or the proxy outputs the predicted value of the second measurement value instead of the actual measurement value at least during the verification of the verification target sensors. Note that the system may be a control system including an ICS or an information system. In addition, as a computer program product or as a system, the present invention can also naturally have the substantially same technical features as in the aforementioned case where the present invention is described as a method.

### BRIEF DESCRIPTION OF THE DRAWINGS

FIG. 1 is a block diagram showing the architecture of an industrial control system according to an embodiment.

FIG. 2 is a flowchart for explaining an operation of the industrial control system according to the embodiment.

FIGS. 3A, 3B, and 3C illustrate the operation of the industrial control system according to the embodiment.

FIGS. 4A, 4B, and 4C illustrate an operation of a conventional industrial control system.

FIG. 5 illustrates a mode of using a correlation among sensors in selecting a sensor 4i to be verified.

FIG. 6 illustrates a mode of using a structural dependency among the sensors in selecting the sensor 4i to be verified.

FIG. 7 illustrates a mode of using LARS in selecting the sensor 4i to be verified.

FIG. 8 illustrates a configuration of the ICS according to an example.

FIG. 9 illustrates an operation of the ICS according to the example.

FIG. 10 shows an example of a hardware configuration of a computer 1900 corresponding to an analysis server 5 according to the embodiment.

### DETAILED DESCRIPTION

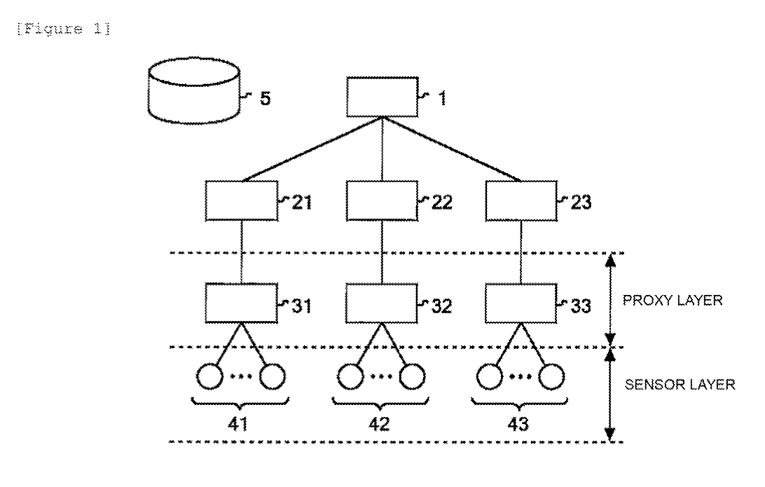

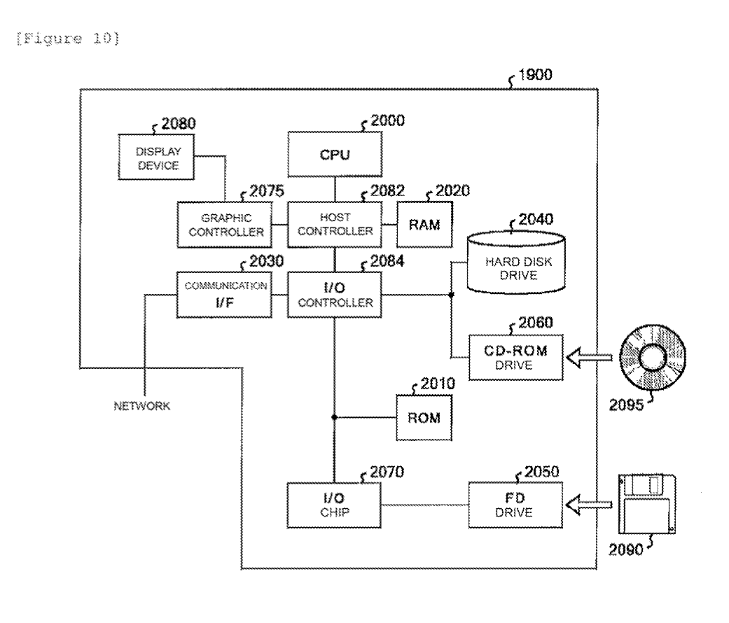

FIG. 1 is a block diagram showing the architecture of an ICS according to an embodiment. The ICS includes subsystems which are a single higher-level ICS1 and multiple (three) lower-level ICS 21, ICS 22, and ICS 23. The higher-level ICS1 is connected to each of the lower-level ICSs 21 to 23. Moreover, the lower-level ICSs 21 to 23 are connected to sensor groups 41, 42, and 43 through proxies 31, 32, 33, respectively. Each of the sensor groups 41 to 43 may be a group of sensors of the same type or different types. Further, the ICS according to this embodiment includes an analysis server 5. The analysis server 5 is connected to the proxies 31 to 33 and the higher-level ICS1 (illustration thereof is omitted). The analysis server 5 may be connected to the lower-level ICSs 21 to 23 instead of the higher-level ICS1. In addition, the analysis server 5 may be a single apparatus or may be divided into multiple apparatuses according to a function thereof. More specific hardware configuration of the analysis server 5 will be described later with reference to FIG. 10.

Note that an ICS is a system including multiple computers and apparatuses connected therein. In an example, the ICS manages and controls objects in an industrial system, an infrastructure (such as transportation or energy) system or similar system. In an example, the ICS manages various devices (for example, electricity, gas, water, air conditioning, and security systems and the like) connected to a network in a building. The ICS may also be part of a single large control system. For example, the ICS may be part (for example, a building management system, a factory management system, a water management system, an electricity management system or the like) of an overall city management system. The ICS may also manage various devices (for example, telephones, copiers, and the like) connected to a network in an office or a home.

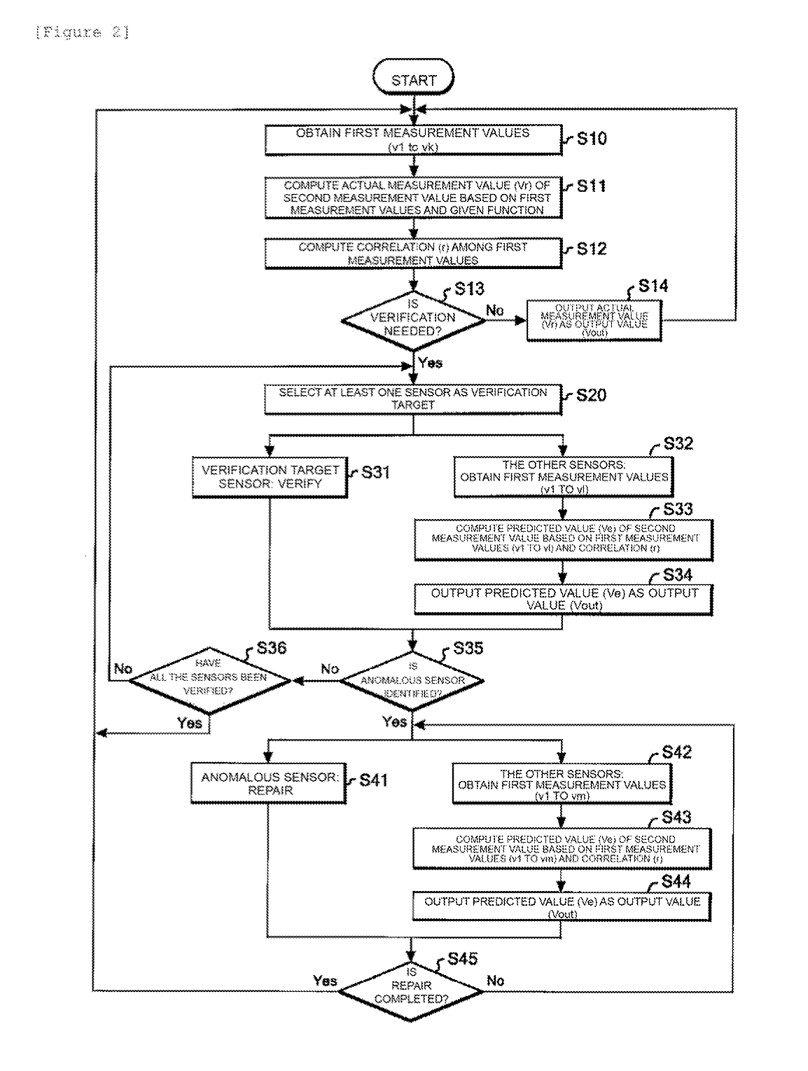

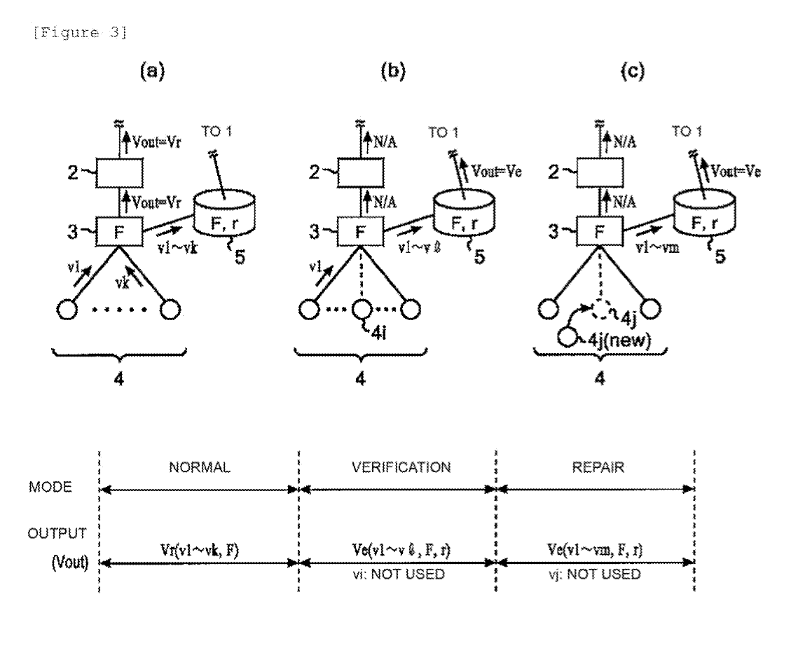

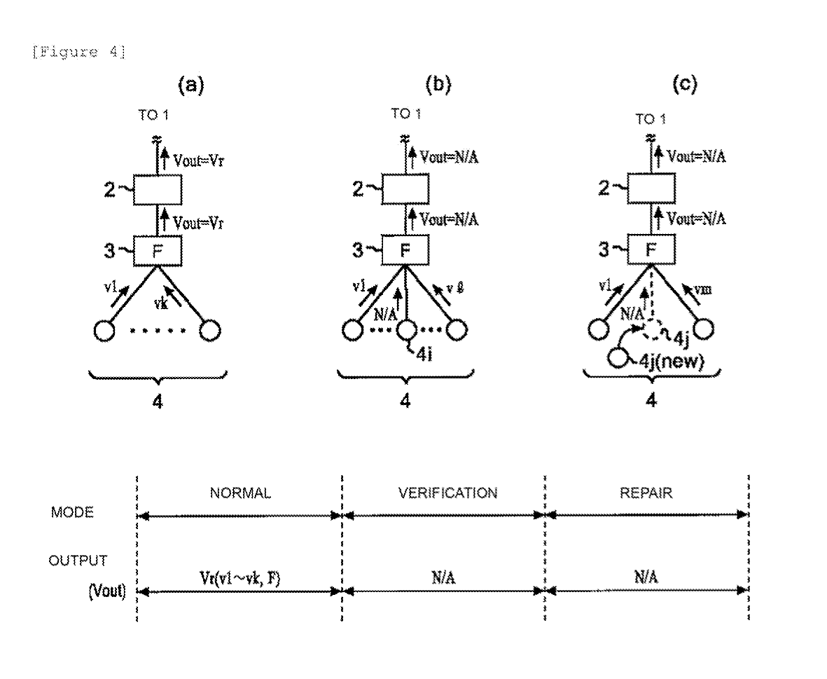

FIG. 2 is a flowchart for explaining an operation of the ICS according to this embodiment. FIGS. 3A to 3C are diagrams for explaining operations of the subsystem and the analysis server 5 according to this embodiment. FIGS. 4A to 4C are diagrams for explaining an operation of a conventional subsystem for the sake of comparison. Hereinbelow, a basic operation of the ICS according to this embodiment will be described by referring to the drawings. Note that FIGS. 3A to 4C show a lower-level ICS2 representing one of the lower-level ICSs 21 to 23, a proxy 3 representing one of the proxies 31 to 33, and a sensor group 4 representing one of the sensor groups 41 to 43. The sensor group 4 is constituted of k sensors.

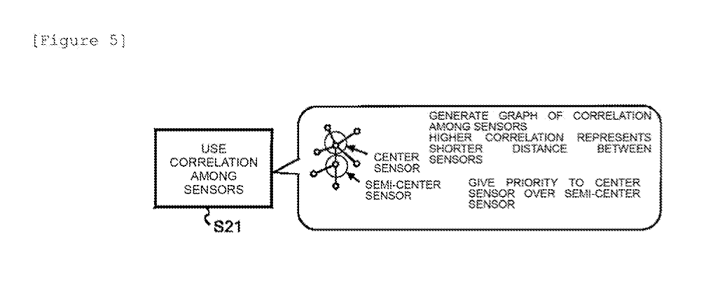

First, a description is given of a normal mode shown in FIG. 3A. The proxy 3 obtains first measurement values v1 to vk from the sensor group 4 (Step S10 in FIG. 2). The proxy 3 also computes an actual measurement value Vr of a second measurement value based on the first measurement values v1 to vk and a given function F (Step S11 in FIG. 2) to output the actual value Vr as an output value Vout to the lower-level ICS2. The lower-level ICS2 outputs the actual measurement value Vr as the output value Vout further to a higher-level ICS1. The proxy 3 also observes temporal change of the obtained first measurement values v1 to vk for a certain time period, and computes and stores therein a correlation r among the first measurement values v1 to vk (Step S12 in FIG. 2). At this time, the proxy 3 computes a value of correlation among the first measurement values v1 to vk from the sensors. The correlation can be used not only for interpolation to be described later but also for selection of a sensor 4i to be verified shown in FIG. 5. Incidentally, the function F may be of arbitrary form such as a function of obtaining an arithmetic average or a weighted average of the first measurement values v1 to vk, for example.

Next, it is determined whether or not sensor verification is needed (Step S13 in FIG. 2). For example, the ICS may be configured to perform the sensor verification regularly. The ICS may be configured to perform the sensor verification when the actual measurement value Vr indicates a predetermined anomaly value. Verification mode may be triggered by any of the higher-level ICS1, the lower-level ICS2, and the analysis server 5. Note that while the verification is not needed, the aforementioned actual measurement value Vr is continued to be outputted as the output value Vout from the proxy 3 to the higher-level ICS1 through the lower-level ICS2 (Step S14 in FIG. 2) without any extra step.

Next, a description is given of the verification mode shown in FIG. 3B. Firstly, at least one sensor as a verification target is selected (Step S20 in FIG. 2). One or more sensors 4i may be verified at a time, but a preferable number of the sensors 4i is a sufficiently small number relative to the total number of the sensors in the sensor group 4. Each sensor 4i as a verification target is selected in descending order of contribution to the aforementioned actual measurement value Vr of the second measurement value. The details will be described later by referring to FIGS. 5 to 7. In the verification mode, the selected certain sensor 4i is verified (Step S31 in FIG. 2). Any verification method can be employed. A sensor may be verified automatically by executing an anomaly detection program, verified manually by an operator, or verified by combining these. The sensor verification is repeated with a verification target selected in turn, until an anomalous sensor is identified (Step S35 in FIG. 2) or all the sensors belonging to the sensor group 4 are verified (Step S36).

In the verification mode, the analysis server 5 also obtains first measurement values v1 to vl during the verification from the other sensors (among the sensors in the sensor group 4, the sensors excluding the sensor 4i under verification and including both a sensor yet to be verified and a sensor proved not to be anomalous by the verification) through the proxy 3 (Step S32 in FIG. 2). The analysis server 5 interpolates the first measurement value of the sensor 4i under verification based on the first measurement values v1 to vl and the aforementioned correlation r computed in the normal mode. The interpolation can employ a known method. For example, based on the correlation shown in Step S12 in FIG. 2, a value of a sensor (not under verification; i.e. before or after verification) having a high correlation with the sensor under verification can substitute for an anomalous value. Alternatively, a prediction model (such as a multiple regression model) of the sensor under verification can be used using only values of the sensors not under verification while the model is calculated from normal data beforehand. Further, the analysis server 5 computes a predicted value Ve of the second measurement value based on: the first measurement values v1 to vl obtained from the other sensors; an interpolated first measurement value vi of the sensor 4i under verification; and the given function F (Step S33 in FIG. 2). The analysis server 5 outputs the predicted value Ve of the second measurement value as the output value Vout to the higher-level ICS1 (Step S34 in FIG. 2). In this case, the system may be configured to stop output from the proxy 3 and the lower-level ICS2 (N/A) as shown in FIG. 3B, or configured to not stop the output from the proxy 3 and the lower-level ICS2 and to employ output from the analysis server 5 in the higher ICS1 instead of output from the lower-level ICS2.

Next, a description is given of repair mode shown in FIG. 3C. In the repair mode, the identified anomalous sensor is repaired (or replaced). Note that one or more sensors 4j are assumed to be repaired at a time, but the number of the sensors is preferably a sufficiently small number relative to the total number of the sensors in the sensor group 4. In the repair mode, the analysis server 5 also obtains first measurement values v1 to vm from the other sensors (among the sensors in the sensor group 4, the sensors excluding any sensor 4j under repair) through the proxy 3 (Step S42 in FIG. 2). The analysis server 5 interpolates the first measurement value of the sensor 4j under repair, based on the first measurement values v1 to vm and the aforementioned correlation r computed in the normal mode. Further, the analysis server 5 computes a predicted value Ve of the second measurement value based on: the first measurement values v1 to vm obtained from the other sensors; an interpolated first measurement value vj of the sensor 4j under repair; and the given function F (Step S43 in FIG. 2). The analysis server 5 outputs the predicted value Ve of the second measurement value as the output value Vout to the higher-level ICS1 (Step S44 in FIG. 2). In this case, the system may be configured to stop output from the proxy 3 and the lower-level ICS2 (N/A) as shown in FIG. 3C, or configured to not stop the output from the proxy 3 and the lower-level ICS2 and to employ output from the analysis server 5 in the higher-level ICS1 instead of output from the lower-level ICS2.

A summary is given below while making a comparison in operation between the ICS according to this embodiment shown in FIGS. 3A to 3C and the conventional ICS shown in FIGS. 4A to 4C. In the normal mode, both the higher-level ICS1 according to this embodiment and the conventional higher-level ICS obtain the actual measurement value Vr of the second measurement value as the output value Vout in the same manner. However, in the verification mode and the repair mode, the conventional higher-level ICS cannot obtain the output value Vout, but the higher-level ICS1 according to this embodiment can obtain the predicted value Ve of the second measurement value as the output value Vout. In other words, the operation of the system is not stopped even during verification or repairing, so that the availability of the system can be enhanced. Consequently, it is possible to perform more accurate anomaly detection and more appropriate repairing. Specifically, concerning the more accurate anomaly detection, ensuring the availability makes it possible to lower a threshold for anomaly detection, thus resulting in a higher anomaly detection possibility. As for the more appropriate repairing, verifying the sensors in descending order of contribution results in a higher recovery rate (early recovery).

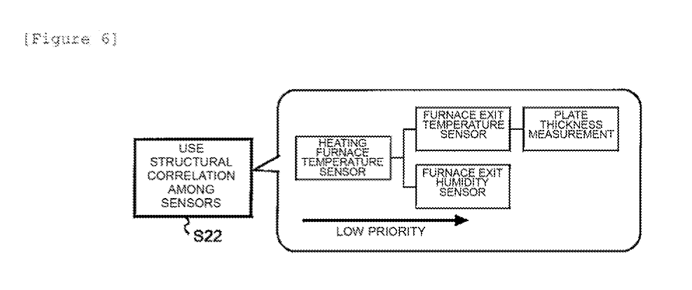

Here, a more specific description is given of selection of the sensor 4i to be verified (Step S20 in FIG. 2). As described above, the sensor 4i to be verified is selected in the descending order of contribution to an actual measurement value of the second measurement value. However, a sensor having a correlation with more sensors may be determined as a sensor having higher contribution to the actual measurement value of the second measurement value (see FIG. 5). Alternatively, the determination can be made based on a structural dependency among the sensors (see FIG. 6), LARS or combining these.

FIG. 5 illustrates a mode of using a correlation among sensors (Step S21 in FIG. 5) in selecting the sensor 4i to be verified (Step S20 in FIG. 2). Specifically, the presence of a correlation of each sensor with the other sensors is shown by a line and the degree of the correlation is shown by the length of the line (a distance between sensors). A sensor having a correlation with other 5 sensors is herein referred to as a “center sensor,” and a sensor having a correlation with other 3 sensors is referred to as a “semi-center sensor.” Higher priority is given to the center sensor compared to the semi-center sensor (as a verification target). If multiple sensors have the same number of correlated sensors, priority is determined among the multiple sensors in descending order of the correlation.

FIG. 6 illustrates a mode of using a structural dependency among the sensors (Step S22 in FIG. 6) in selecting the sensor 4i to be verified (Step S20 in FIG. 2). In other words, a manufacturing process of arranging the sensors is focused, and higher priority is given to a sensor arranged on a more upstream side of the manufacturing process. For example, suppose a case where a pressure furnace sensor, a furnace exit temperature sensor, a furnace exit humidity sensor, and a plate thickness measurement sensor are installed on a manufacturing line of an iron plate factory in this order from the upstream side to the downstream side, as shown in FIG. 6. In this case, the sensors can be verified in this order.

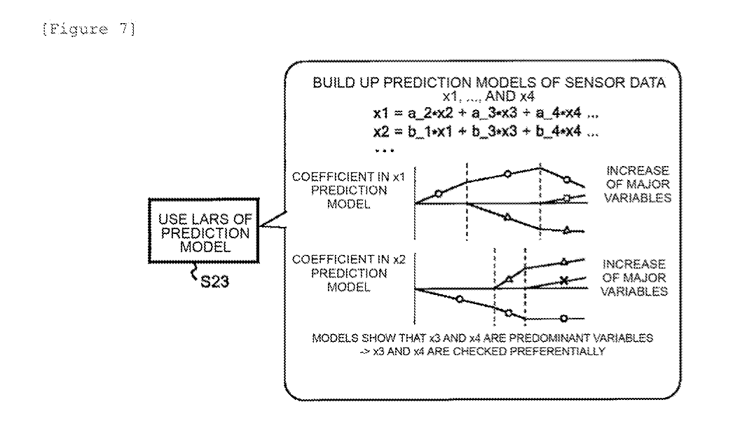

FIG. 7 illustrates a mode of using LARS-based variable selection (Step S23 in FIG. 7) in selecting the sensor 4i to be verified (Step S20 in FIG. 2). In LARS, the number of explanatory variables for the regression can be increased or decreased by changing regularization parameters. Generally, the prediction accuracy is enhanced with the increase of the number of variables. For example, in FIG. 7, x1 is represented by a cross mark; x2, a square; x3, a circle; and x4, a triangle. FIG. 7 shows a result of increasing the number of explanatory variables in an x1 prediction model. If there is a single explanatory variable, x3 is selected as the most accurate explanatory variable. If there are two explanatory variables, x3 and x4 are selected, and then x2 is added. Similarly, in a behavior in an x2 prediction model (lower part of FIGS. 7), x3, x4, and x1 are added to the model in this order as the explanatory variables. Accordingly, x3 and x4 are determined to have higher contribution to the x1 and x2 prediction models. Priority is given to x3 and x4 in this order to perform verification. In this respect, sensors corresponding to x3 and x4 should be verified preferentially.

### Example

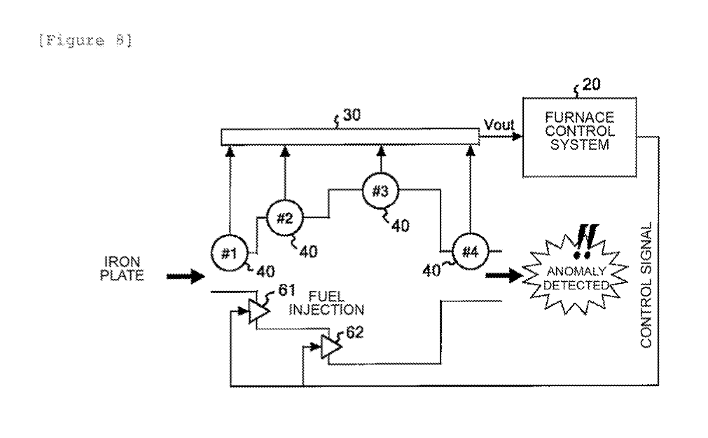

More specifically, an example of applying the present invention to a hot rolling process for an iron plate will be described as an example. FIG. 8 illustrates a configuration of an ICS according to the example. In the example, a pressure furnace sensor group 40, a furnace exit temperature sensor (unillustrated), a furnace exit humidity sensor (unillustrated), and a plate thickness measurement sensor (unillustrated) are installed on a manufacturing line of an iron plate factory in this order from the upstream side to the downstream side. Four sensors (#1, #2, #3, and #4) forming the pressure furnace sensor group 40 are provided in the furnace. An average of data obtained from the pressure furnace sensors is outputted as an output value Vout to a furnace control system 20 through a proxy 30. The furnace control system 20 outputs a control signal according to the output value Vout to perform feedback control on operations of fuel injectors 61, 62 in the furnace. A description is given below of how the iron-plate hot rolling control system as described above operates in a case of an anomalous plate thickness.

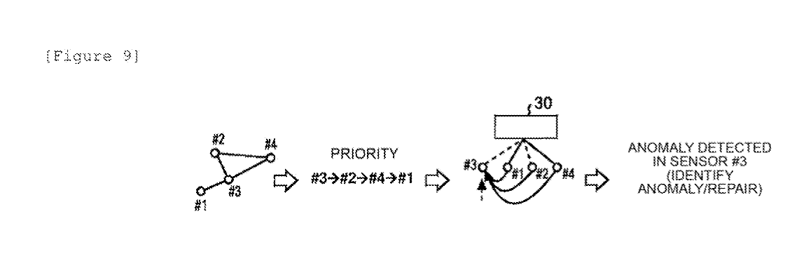

FIG. 9 illustrates a configuration of an ICS according to the example. In response to an anomalous value of data obtained from the plate thickness measurement sensor, the furnace control system 20 enters the verification mode from the normal mode (see Step S13 in FIG. 2). Sensors which are verification targets are selected in turn from the pressure furnace sensor group 40 to perform verification thereof. In this case, priority (#3, #2, #4, and #1 in this order) is determined based on a correspondence among the pressure furnace sensors (see FIG. 5). For example, when a failure is found in the sensor (#3) as the first verification target in the pressure furnace sensor group 40, the sensor (#3) is repaired subsequently. Meanwhile, during each of the sensor verification and repairing, an analysis server (unillustrated) continues to output a predicted value Ve as the output value Vout (see Steps S34 and S44 in FIG. 2) on the basis of a correlation r computed and stored in the normal mode (see Step S12 in FIG. 2). Thus, it is possible to perform the verification and repairing the pressure furnace sensor group 40 (see Steps 31 and 41 in FIG. 2) without stopping the iron-plate hot rolling process.

FIG. 10 shows an example of a hardware configuration of a computer 1900 corresponding to the analysis server 5 according to the embodiment. The computer 1900 according to this embodiment includes a CPU peripheral portion including a CPU 2000, a RAM 2020, a graphic controller 2075, and a display device 2080 which are connected with each other via a host controller 2082. The computer 1900 further includes an input/output portion including a communication interface 2030 connected to the host controller 2082 via an input/output controller 2084, a hard disk drive 2040, and a CD-ROM drive 2060. The computer 1900 further includes a legacy input/output portion including a ROM 2010 connected to the input/output controller 2084, a flexible disk drive 2050, and an input/output chip 2070.

The host controller 2082 connects the RAM 2020, the CPU 2000 and the graphic controller 2075 together, the CPU 2000 and the graphic controller 2075 which access the RAM 2020 at a high transfer rate. The CPU 2000 operates based on programs stored in the ROM 2010 and the RAM 2020 and controls each of the components. The graphic controller 2075 acquires image data generated by the CPU 2000 and the like on a frame buffer provided in the RAM 2020 and displays the image data on the display device 2080. Alternatively, the graphic controller 2075 may also include, in the graphic controller 2075, the frame buffer for storing the image data generated by the CPU 2000 and the like.

The input/output controller 2084 connects the communication interface 2030, the hard disk drive 2040, and the CD-ROM drive 2060 which are relatively high speed input/output devices, to the host controller 2082. The communication interface 2030 communicates with another device via a network. The hard disk drive 2040 stores therein programs and data used by the CPU 2000 in the computer 1900. The CD-ROM drive 2060 reads a program and the data from a CD-ROM 2095 and then provides them to the hard disk drive 2040 via the RAM 2020.

Relatively low speed input/output devices such as the ROM 2010, the flexible disk drive 2050, and the input/output chip 2070 are connected to the input/output controller 2084. The ROM 2010 stores therein a boot program executed by the computer 1900 at a start-up time of the computer 1900 and/or programs depending on the hardware of the computer 1900, and the like. The flexible disk drive 2050 reads a program and data from the flexible disk 2090 and then provides them to the hard disk drive 2040 via the RAM 2020. The input/output chip 2070 connects the flexible disk drive 2050 to the input/output controller 2084 and connects the various input/output devices via, for example, a parallel port, a serial port, a keyboard port, a mouse port and the like.

The programs provided to the hard disk drive 2040 via the RAM 2020 have been stored in a recording medium such as the flexible disk 2090, the CD-ROM 2095 or an IC card. The programs are provided by the user. Each of the programs is read from the recording medium, installed on the hard disk drive 2040 in the computer 1900 via the RAM 2020, and executed by the CPU 2000.

The program installed on the computer 1900 to cause the computer 1900 to function as a management system 30 includes a workflow database module, a response database module, an event analysis module, and a communication management module. The program or the modules cause the computer 1900 to function as the aforementioned analysis server 5 by working in cooperation with the CPU 2000 or the like.

The computer 1900 reads information processing described in the program and thereby functions as the analysis server 5 which is specific means achieved by software and the aforementioned hardware resources in cooperation with each other. Then, computation or processing of information according to usage of the analysis server 5 in this embodiment is achieved by using the specific means, and thereby a particular ICS according to the usage is built up.

In an example, when the computer 1900 communicates with an external device, the CPU 2000 executes a communication program loaded on the RAM 2020 and instructs the communication interface 2030 to execute communication processing in accordance with processing details described in the communication program. Under control of the CPU 2000, the communication interface 2030 reads transmission data stored in a transmission buffer area or the like provided in the storage device such as the RAM 2020, the hard disk drive 2040, the flexible disk 2090 or the CD-ROM 2095, and then transmits the data to a network. The communication interface 2030 also writes data received from the network, to a reception buffer area provided in the storage device. As described above, the communication interface 2030 may transfer data to and from the storage device by a direct memory access (DMA) method. Alternatively, the CPU 2000 may transfer data by reading data from a storage device or a communication interface 2030 which is a transfer source and writing the data to a communication interface 2030 or a storage device which is a transfer target.

The CPU 2000 causes the RAM 2020 to read all or necessary part of data of a file, a database or the like stored in the external storage device such as the hard disk drive 2040, the CD-ROM drive 2060 (the CD-ROM 2095) or the flexible disk drive 2050 (the flexible disk 2090) through the DMA transfer or the like, and performs various processing on the data in the RAM 2020. The CPU 2000 then writes the data subjected to the processing back to the external device through the DMA transfer or the like. The RAM 2020 is considered to temporarily hold the data in the external storage device in the processing described above. Thus, in this embodiment, the RAM 2020, the external storage device, and the like are collectively referred to as a memory, a storage unit, a storage device or the like. The various programs and information such as data, tables, and databases in this embodiment are stored in the storage device and are to be subjected to information processing. Note that some data in the RAM 2020 may be held in a cache memory and be read and written therefrom and thereto by the CPU 2000. The cache memory serves as part of the RAM 2020 also in such a mode. Thus, the cache memory is also included in the RAM 2020, the memory and/or the storage device in this embodiment, unless otherwise distinguished.

The CPU 2000 performs various computations described in this embodiment and various processing including information processing, a conditional judgment, an information search or replacement, and the like on the data read from the RAM 2020, and writes the data back to the RAM 2020. The computations and processing are each designated by a command string in a program. For example, when performing a conditional judgment, the CPU 2000 judges whether each of the various variables shown in this embodiment satisfies a condition that the variable is, for example, larger than, smaller than, not less than, not more than, or equal to the other variables or a constant. If the condition holds (or does not hold) true, the processing branches to a different command string, or a subroutine is called.

The CPU 2000 can also perform searching for information stored in a file, a database or the like in the storage device. For example, suppose a case where the storage device stores therein multiple entries each having an attribute value of a first attribute and an attribute value of a second attribute which are associated with each other. In this case, the CPU 2000 searches the entries stored in the storage device for an entry satisfying a certain condition of designating an attribute value of the first attribute, and then reads an attribute value of the second attribute stored in the found entry. Thereby, the CPU 2000 can obtain the attribute value of the second attribute which is associated with the first attribute and satisfies the condition.

The program and the modules described above may be stored in an external recording medium. As the recording medium, an optical recording medium such as a DVD or a CD, a magneto-optical recording medium such as an MO, a tape medium, a semiconductor memory such as an IC card, or the like may be used as well as the flexible disk 2090 and the CD-ROM 2095. In addition, a storage device such as a hard disk or a RAM provided in a server system connected to a dedicated communication network or the Internet may be used as the recording medium to provide the computer 1900 with the program through the network.

For example, embodiments of the present invention may include a computer program product for interpolating sensor data at a control system, the control system including a plurality of sensors, a proxy, and a server. The computer program product comprising a computer readable storage medium having computer readable program code embodied therewith, the computer readable program code configured to: measure objects by the plurality of sensors to obtain first measurement values, respectively; compute a correlation among the first measurement values by the server based on the first measurement values; compute an actual measurement value of a second measurement value by the proxy based on the first measurement values and a given function; verify the plurality of sensors by setting one or more sensors as verification target sensors in turn by the server at a predetermined timing; compute a predicted value of the second measurement value by the server based on the correlation and the first measurement values obtained from other sensors, the other sensors consist of the plurality of sensors excluding the verification target sensors; and output the predicted value of the second measurement value instead of the actual measurement value thereof at least during the verification of the verification target sensors if an anomalous sensor is identified. The computer readable program code may be configured to verify the plurality of sensors is further configured to verify one or more verification target sensors among the plurality of sensors in turn until the anomalous sensor is identified, and the computer program product may further comprise computer readable program code configured to: in response to the identification of the anomalous sensor, compute the predicted value of the second measurement value by the server based on the correlation and the first measurement values obtained from the other sensors except the verification target sensors among the plurality of sensors; and output the predicted value by the server at least during a repair of the anomalous sensor. The computer readable program code may be configured to verify the plurality of sensors is further configured to verify one or more verification target sensors among the plurality of sensors in turn until the anomalous sensor is identified, and in response to identification of no anomalous sensor in all the plurality of sensors, output the actual value of the second measurement value instead of the predicted value. The other sensors may include sensors already verified. The computer readable program code may be configured to verify the plurality of sensors is further configured to verify the sensors in descending order of contribution to the actual measurement value of the second measurement value. The computer readable program code may be configured to verify the plurality of sensors is further configured to verify the verification target sensors among the plurality of the sensors in turn in response to identification of the actual measurement value taking on a predetermined anomalous value. The control system may comprise a single higher-level subsystem and a plurality of lower-level subsystems, the lower-level subsystems each comprise the proxy and the plurality of sensors, and the server outputs the predicted value to the higher-level subsystem in the output step.

Embodiments of the present invention may include a system comprising: a plurality of sensors to measure objects to obtain first measurement values, respectively; a first server to compute a correlation among the first measurement values based on the first measurement values; a proxy to compute an actual measurement value of a second measurement value based on the first measurement values and a given function; and a second server to verify the plurality of sensors by setting one or more sensors as verification target sensors in turn at predetermined timing; wherein the second server computes a predicted value of the second measurement value based on the correlation and the first measurement values obtained from the other sensors except the verification target sensors among the plurality of sensors; and wherein one of the first and second servers and the proxy outputs the predicted value of the second measurement value instead of the actual measurement value thereof at least during the verification of the verification target sensors if an anomalous sensor is identified. The second server may be configured to: verify one or more verification target sensors among the plurality of sensors in turn until the anomalous sensor is identified, and in response to the identification of the anomalous sensor; compute the predicted value of the second measurement value based on the correlation and the first measurement values obtained from the other sensors except the verification target sensors among the plurality of sensors; and output the predicted value by the server at least during a repair of the anomalous sensor. The second server may be configured to: verify one or more verification target sensors among the plurality of sensors in turn until all of the plurality of sensors are verified, and output, in response to identification of no anomalous sensor in all the plurality of sensors, the actual value of the second measurement value instead of the predicted value in the output step. The other sensors may include sensors already verified. The sensors may be verified in descending order of contribution to the actual measurement value of the second measurement value. The verification target sensors among the plurality of the sensors may be verified in turn in response to identification of the actual measurement value taking on a predetermined anomalous value. The control system may comprise a single higher-level subsystem and a plurality of lower-level subsystems, the lower-level subsystems each comprise the proxy and the plurality of sensors, and the server outputs the predicted value to the higher-level subsystem in the output step.

The description has heretofore been given by using the embodiment. However, a technical scope of the present invention is not limited to a scope of the embodiment described above. It is obvious to those skilled in the art that various modifications or improvements can be additionally provided to the aforementioned embodiment. From the description of the scope of claims, it is apparent that the technical scope of the present invention should include embodiments with such modifications or improvements.

It should be noted that an explicit description by specially stating “before,” “prior to,” or the like is not provided to the order of executing various processing such as operations, procedures, steps, stages and the like in the device, the system, the program, and the method which are shown in the scope of claims, and thus the processing can be achieved in any order except a case where output of preceding processing is used for subsequent processing. Even if a description is given of a flow of operations in the scope of claims, the specification, and the drawings by conveniently using “firstly,” “next,” or the like, the description does not mean that the operations indispensably need to be performed in the order.

The present invention can provide a method, a computer program, or a system by which even if anomalous data indicating a failure or the like is detected from a certain sensor, the system is operated as continuously as possible without stopping part or the entirety of the system. In addition, high availability is ensured, and a threshold showing a data anomaly can be set low. As the result, an anomaly can be detected more accurately.

What is claimed is:

1. A method for interpolating sensor data at a control system, the control system including a plurality of sensors, a proxy, and a server; the method comprising the steps of:
measuring objects by the plurality of sensors to obtain first measurement values, respectively;
computing a correlation among the first measurement values by the server based on the first measurement values;
computing an actual measurement value of a second measurement value by the proxy based on the first measurement values and a given function;
verifying the plurality of sensors by setting one or more sensors as verification target sensors in turn by the server at a predetermined timing;
computing a predicted value of the second measurement value by the server based on the correlation and the first measurement values obtained from other sensors, the other sensors consist of the plurality of sensors excluding the verification target sensors; and
outputting the predicted value of the second measurement value instead of the actual measurement value thereof at least during the verification of the verification target sensors if an anomalous sensor is identified.

2. The method according to claim 1, wherein
in the verification step, one or more verification target sensors among the plurality of sensors are verified in turn until the anomalous sensor is identified, and
the method further comprises the steps of:
in response to the identification of the anomalous sensor,
computing the predicted value of the second measurement value by the server based on the correlation and the first measurement values obtained from the other sensors except the verification target sensors among the plurality of sensors; and
outputting the predicted value by the server at least during a repair of the anomalous sensor.

3. The method according to claim 1, wherein
in the verification step, one or more verification target sensors among the plurality of sensors are verified in turn until all of the plurality of sensors are verified, and
in response to identification of no anomalous sensor in all the plurality of sensors, the actual value of the second measurement value is outputted instead of the predicted value in the output step.

4. The method according to claim 1, wherein the other sensors include sensors already verified.

5. The method according to claim 1, wherein in the verification step, the sensors are verified in descending order of contribution to the actual measurement value of the second measurement value.

6. The method according to claim 1, wherein in the verification step, the verification target sensors among the plurality of the sensors are verified in turn in response to identification of the actual measurement value taking on a predetermined anomalous value.

7. The method according to claim 1, wherein
the control system comprises a single higher-level subsystem and a plurality of lower-level subsystems,
the lower-level subsystems each comprise the proxy and the plurality of sensors, and
the server outputs the predicted value to the higher-level subsystem in the output step.
